(19) United States
(12) Patent Application Publication
(10) Pub. No.: US 2020/0311136 A1
(43) Pub. Date: Oct. 1, 2020

(54) MEASURING AND INCREASING THE QUALITY OF USER-PROVIDED INFORMATION

(71) Applicant: Healthblock, Inc., Palo Alto, CA (US)

(72) Inventors: Brian JUN, Mountain View, CA (US); Jan T. LIPHARDT, Palo Alto, CA (US)

(21) Appl. No.: 16/364,168

(22) Filed: Mar. 25, 2019

(51) Int. Cl. G06F 16/906; H04W 4/18; G06N 20/20; G06F 16/909

(52) U.S. Cl. CPC G06F 16/906; G06F 16/909; G06N 20/20; H04W 4/185

(57) ABSTRACT

Methods, systems and computer program products for data analytics. Multiple components are interconnected to carry out operations for said data analytics. A method commences upon establishing a connection with a user device that is associated with a user. The user operates the user device to produce a plurality of datasets that correspond to a plurality of differing data regimes. The plurality of datasets from the different data regimes are analyzed to determine spatial and temporal correlations between the datasets. The quality score is in turn based on the determined spatial and temporal correlations. To improve the quality score, specific action requests are sent to the user device. The specific action requests are based on a comparison between the quality score and a quality score threshold. To protect against spoofing, capture time windows of respective datasets selected from the differing data regimes are analyzed to verify the provenance of the datasets.

### TECHNICAL FIELD

This disclosure relates to data analytics, and more particularly to techniques for measuring the quality of information that is provided over the Internet.

### BACKGROUND

With the continued proliferation of information sensing devices (e.g., cameras, RFID tags, location sensors, etc.) that are ubiquitous in today's “everywhere online” computing environments (e.g., involving mobile phones, online computers, etc.), increasingly larger volumes of data are collected and analyzed for various business intelligence purposes. For example, the web browsing activities of users on their user devices are captured in various datasets (e.g., cookies, log files, etc.) for use by online advertisers in targeted advertising campaigns. Data from operational sources (e.g., point of sale systems, accounting systems, CRM systems, etc.) can also be combined with the aforementioned data from online sources to further enhance the intelligence derived from the data. The corpora of data from which the intelligence is derived can comprise first-party data (e.g., data collected directly from the users), second-party data (e.g., another entity's first-party data), third-party data (e.g., aggregated data from multiple sources), data collected from the Internet at large, or any combination thereof.

Given such a large corpus of data that is collected from so many varied sources, the quality of the data varies accordingly. As an example, a retailer might decide to survey many people from many demographics to acquire enough market data so as to determine pricing for a new product. The survey respondents might have widely different experiences and/or perspectives pertaining to the new product and, as such, the range of answers to survey questions might vary widely across the overall group of respondents. Moreover, the quality of information received from the respondents as a whole will vary from higher quality data (e.g., from respondents that are relatively more astute about customer tastes and pricing sensitivities) to lower quality data (e.g., from respondents with more limited market insight). In some cases, the quality of the information received might be acceptable for the intended purpose, at least in that there is limited or no incentive for the users to behave maliciously (e.g., by falsifying answers to the survey questions) when providing the data.

In certain settings, the user providing the data may be incented to carry out malicious or fraudulent behavior. For instance, an insured driver who is submitting information (e.g., words, photographs, etc.) pertaining to an accident may be incented to falsify such information to achieve a perceived better outcome (e.g., no fault, waived deductible, higher repair reimbursement, etc.) from his or her insurance company. As another example, a patient seeking healthcare from a remote medical care professional may falsify descriptions and/or photographs of a medical issue to receive certain benefits (e.g., time off from work, prescription refills for drugs, etc.).

In still other settings, the user may not know how data should be collected. As another example, a user without medical training may not know that the height of a suspicious lesion on their arm would help a dermatologist to correctly classify the user's condition, and as such, the user might not know that capturing a photo that shows the height of the lesion would be helpful to the dermatologist.

Unfortunately, techniques for capturing data over the Internet has not kept pace with advances in domain-specific areas such as are found in insurance, actuarial, medical, and pharmaceutical industries, etc. Moreover, techniques for assessing authenticity, relevance, truthfulness and/or other quality attributes pertaining to user-provided information have not kept pace with the technological capabilities for altering or otherwise falsifying such information. As an example, various techniques (e.g., generative adversarial networks (GANs), etc.) are available today that can substantially alter a still image (e.g., photograph) or even a video with little to no detectable distortion, allowing a user to submit fraudulent visual representations (e.g., fraudulent dashcam video, a falsified photograph vehicle damage, a falsified photograph of a physical injury, etc.). Even when certain information is authentic, it may not be relevant or consistent with the intended purpose. For example, a photograph of an injury may be authentic (e.g., verifiably captured by an authenticated user's user device), but may not capture a visual representation of the injury that is sufficient for accurate diagnosis, and/or may not be sufficient in its representation to serve as proof of an incident or injury, etc. What is needed is a way to collect information from user devices such that authenticity, relevance, and other quality attributes can be quantitatively assessed and improved.

### SUMMARY

Data of sufficient quality are needed to make good decisions. This is apparent in a multitude of settings such as in telemedicine (e.g., for accurate diagnosis), in health coaching (e.g., for managing medical conditions), and in settings pertaining to insurance claim processing. In these example settings, information is exchanged over the Internet. However, the quality of data provided over the Internet can be poor or incomplete, for example due to factors such a lack of domain-specific expertise, and/or poor or incomplete data collection by a remote user. Moreover, data that is provided over the Internet is often subject to spoofing or other sorts of malicious attempts to provide misleading information.

The present disclosure describes techniques used in systems, methods, and in computer program products for measuring the quality of user-provided information, which techniques advance the relevant technologies to address technological issues with legacy approaches. More specifically, the present disclosure describes techniques used in systems, methods, and in computer program products for determining veracity and other quantitative measurements of quality pertaining to information received from a user device. Certain embodiments are directed to technological solutions for analyzing data from multiple correlated data regimes to determine quality scores for sets of user-provided information. Certain embodiments carry out a protocol to successively improve the veracity and other qualities of the received data.

The disclosed embodiments modify and improve over legacy approaches. In particular, the herein-disclosed techniques provide technical solutions that address the technical problems attendant to collecting information from user devices and verifying that such information is of sufficient quality for its intended purpose.

The ordered combination of steps of the embodiments serve in the context of practical applications that perform steps for analyzing data from multiple correlated data regimes to determine quality scores for sets of user-provided information. These steps are organized to be highly efficient—at least by virtue of offloading data correlation tasks away from expensive and scarce servers to inexpensive and ubiquitous user devices such as smartphones.

The disclosed techniques for analyzing data from multiple correlated data regimes to determine quality scores for sets of user-provided information overcome long standing yet unsolved technological problems associated with collecting and authenticating information from user devices and verifying that the data is of sufficient authenticity and quality for its intended purpose.

Many of the herein-disclosed embodiments for analyzing data from multiple correlated data regimes to determine quality scores for sets of user-provided information are technological solutions that address technological problems pertaining to cyber-spoofing that arise in the hardware and software arts. Aspects of the present disclosure achieve performance and other improvements in peripheral technical fields including (but not limited to) human-machine interfaces and cyber threat detection.

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure.

FIG. 1 exemplifies a computing environment in which embodiments of the present disclosure can be implemented.

FIG. 2A depicts an information quality measurement technique as implemented in systems that determine quality scores for information received from a user device.

FIG. 2B depicts a healthcare information quality measurement technique as implemented in systems that determine quality scores for information received from a user device.

FIG. 3 presents a block diagram of a system that makes data quality determinations based on information received from a user device.

FIG. 4 depicts a multi-regime data collection technique as implemented in systems that determine quality scores for information received from a user device.

FIG. 5 presents an information quality assessment technique as implemented in systems that determine quality scores for information received from a user device.

FIG. 6 illustrates an information sourcing scenario for making data quality determinations based on information received from a user device.

FIG. 7A and FIG. 7B depict system components as arrangements of computing modules that are interconnected so as to implement certain of the herein-disclosed embodiments.

FIG. 8A and FIG. 8B present block diagrams of computer system architectures having components suitable for implementing embodiments of the present disclosure, and/or for use in the herein-described environments.

### DETAILED DESCRIPTION

Aspects of the present disclosure solve problems associated with using computer systems for collecting information from user devices that is of sufficient quality for its intended purpose. The embodiments address problems that are unique to—and may have been created by—the rise of cyber threats such as “spoofing”. Some embodiments are directed to approaches for analyzing data from multiple correlated data regimes to determine authenticity, relevance and other attributes of user-provided information. The accompanying figures and discussions herein present example environments, systems, methods, and computer program products for determining a quantitative measurement of quality for information received from a user device.

### Overview

Disclosed herein are techniques for analyzing a combination of data from multiple data regimes to determine quality scores for sets of user-provided information. In certain embodiments, data from multiple data regimes are received from a user as the user interacts with a respective user device. Such data regimes might be classified or distinguished as (1) a three dimensional (3D) object data regime, (2) a two dimensional (2D) image data regime, (3) a non-image sensor data regime (e.g., for capturing gyroscopic data), (4) a text-based data regime, (5) a biometrics data regime, and/or (6) other data regimes. For example, a user might use a smart phone to submit multiple scans or images of a target field (e.g., of an injury), gyroscopic data collected while capturing the scans or images, answers to a survey or questionnaire, a fingerprint verification result, the geographical location of the smart phone, and/or other data from or pertaining to the user device and/or its environment.

The foregoing data from the multiple data regimes are then analyzed both individually and in combination so as to determine at least one quality score to assign to the data. Specifically, the quality score is derived in part from measurements of the correlations between various portions of the data. The quality score and other information are then assessed to determine what, if any, additional data may be needed to improve the quality score. When a certain quality score is achieved, an information set (e.g., summary) formed from the data is published for access by one or more data consumers. In certain embodiments, certain portions of the received data may be transformed to facilitate determination of the quality score.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

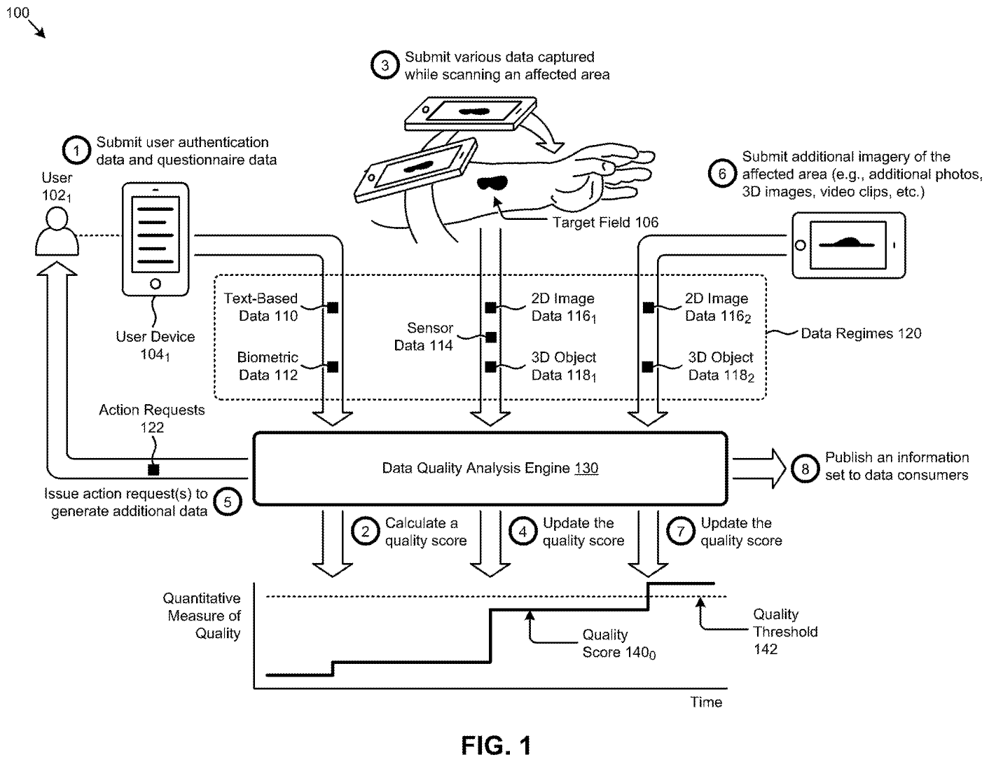

FIG. 1 exemplifies a computing environment 100 in which embodiments of the present disclosure can be implemented. As an option, one or more variations of computing environment 100 or any aspect thereof may be implemented in the context of the architecture and functionality of the embodiments described herein.

FIG. 1 illustrates aspects pertaining to analyzing data from multiple correlated data regimes to determine quality scores for sets of user-provided information. Specifically, the figure presents a logical depiction of how the herein disclosed techniques can be used in a computing environment to collect information from user devices that is of sufficient quality for its intended purpose.

As depicted in FIG. 1, computing environment 100 illustrates a representative user (e.g., user 102₁) from a plurality of users who interacts with a user device 104₁ (e.g., a smart phone). User 102₁ represents one of the many users from whom various data may be collected for business intelligence purposes. For example, user 102₁ may be asked to provide certain information (e.g., sets of data) that pertains to a health issue experienced by the user to prove the existence of the issue, to diagnose the issue, and/or to facilitate other purposes.

Due to the broad variation of skills, experiences, intents, and/or other characteristics of the many users providing such information, the quality of the user-provided data can vary accordingly. In the foregoing health issue scenario, for example, user 102₁ may falsify descriptions and/or photographs of the health issue to receive certain benefits (e.g., time off from work, prescription refills for drugs, etc.). Furthermore, even when the user-provided data is authentic, the data provided may not be relevant or consistent with the intended purpose. For example, a photograph pertaining to the foregoing health provided by user 102₁ may be authentic but may not capture a visual representation of the issue that is sufficient for proof of the issue, diagnosis of the issue, and/or other purposes.

The herein disclosed techniques address such problems attendant to collecting information from user devices such that authenticity, relevance, and other quality attributes can be quantitatively assessed in accordance with what is required for the intended purpose of the user-provided information. As depicted in FIG. 1, such techniques disclosed herein can be facilitated by a data quality analysis engine 130 in computing environment 100. As shown and described by a set of high order operations, data quality analysis engine 130 ingests various datasets from multiple instances of data regimes 120 to determine a quantitative measurement of quality, such as a quality score 140₀.

As used herein, a data regime is defined by the type of data and/or techniques for collection of that data that are distinguishable from another type of data and/or techniques of collection of the other type of data that are defined by a second data regime. As such, a first data regime is based on a first set of techniques for data collection or based on a first set of characteristics of the data itself, whereas a second data regime is based on a different second set of techniques for data collection or based on a second set of characteristics of the data itself. Distinguishing characteristics might pertain to the purpose, structure, encoding and/or other characteristics of the data.

For example, in a first data regime, a particular 2D image dataset might be generated at or by the user's mobile device for the purpose of visually representing a view area, then the 2D image might be encoded using JPEG compression and then structured for storage as a file with a “.jpg” extension. In contrast, in a different data regime, a particular text-based dataset might be generated for the purpose of recording certain language elements, then encoded using ASCII character codes and then structured for storage as a file with a “.txt” extension. In exemplary cases, the type of transducer used to collect the data can be a distinguishing characteristic. For example, image data in a first data regime may be collected from an image sensor, gyroscopic data in a second data regime may be collected from an accelerometer, and location data in a third data regime may be collected from a global positioning system module (GPS module).

Nonlimiting examples of the data of the several data regimes (e.g., data regimes 120) discussed herein respectively comprise text-based data, biometric data, 2D image data, sensor data, and 3D object data, video data, and so on. Other data regimes that comprise other data are possible. According to the herein disclosed techniques, such data over multiple data regimes are manipulated (e.g., analyzed, combined, integrated, correlated, etc.) to determine quality scores for sets of user-provided information. Moreover, application of the herein-disclosed techniques serve to generate quantitative measurements of a correlations (e.g., using measurements of consistencies, using measurements of similarities, using measurements of differences, etc.) between various datasets from the data regimes.

In the scenario depicted in FIG. 1, user 102₁ submits user authentication data and questionnaire data from user device 104₁ to data quality analysis engine 130 (operation 1). For example, user 102₁ might log in to an application at user device 104₁ using a fingerprint identification capability at the user device. Such fingerprint identification data and/or other data might be submitted to data quality analysis engine 130 as a set of biometric data 112. The application at user device 104₁ might then prompt the user to answer a sequence of questions to characterize the context of the subject health issue. For example, the questions might traverse a logical tree of potential questions in accordance with previous answers to gather a certain level of detail about the subject health issue. Such questionnaire response data and/or other data might be submitted to data quality analysis engine 130 as a set of text-based data 110.

In response to receiving biometric data 112 and text-based data 110, data quality analysis engine 130 analyzes the data to calculate a quality score (operation 2). In some cases, biometric data 112 and text-based data 110 may be the first sets of data received from the user. In other cases, earlier received and analyzed data may be combined with the just-received data to determine the quality score. As can be observed, a modest increase in quality score 140₀ is exhibited in response to receiving biometric data 112 and text-based data 110.

To supplement the foregoing user-provided data, user 102₁ interacts with user device 104₁ to submit various data generated while scanning an affected area associated with the subject health issue (operation 3). For example, if user 102₁ identified the health issue as a “rash” on the “left forearm”, images of the rash and/or field around the rash (e.g., target field 106) and the area surrounding the rash might be captured at user device 104₁ by user 102₁. The images of target field 106 is then submitted as a set of 2D image data 116₁ to data quality analysis engine 130. Various instances of sensor data 114 generated before, during, or after the image capture are also issued to data quality analysis engine 130. For example, a set of depth data (e.g., from an iPhone TrueDepth camera) and/or gyroscope data that can be correlated to the image may be generated at user device 104₁ and issued to data quality analysis engine 130.

In some embodiments, a user device includes multiple cameras and multiple respective image sensors. Such multiple cameras may include apertures on the user-facing side of the device and/or may include apertures on the obverse side of the device. In some cases, one or two (or more) cameras of the obverse side of the user device can be used for capture while corresponding real-time imagery, including depth rendering, is displayed on the user-facing side of the device. This technique often aids the user to capture better video clips or still images.

In many cases, certain portions of the 2D image data 116₁ and the sensor data 114 may be combined to form one or more sets of 3D object data 118₁ (e.g., point clouds). Such 3D object datasets can be generated at user device 104₁ and/or at data quality analysis engine 130.

In response to receiving the 2D image data 116₁, sensor data 114, and 3D object data 118₁, the quality score is updated by data quality analysis engine 130 (operation 4). As can be observed, a substantial increase in quality score 140₀ is exhibited in response to receiving the data. However, as can also be observed, the increased quality score remains below a quality threshold 142. Such quality thresholds might be established to facilitate a determination as to whether a set of data and/or information is to be deemed sufficient for a particular purpose. As such, the quality threshold may be higher for some purposes and lower for others. For example, a quality threshold associated with proving the existence of a health issue may be lower than a quality threshold associated with diagnosing a health issue, since the latter will often require more fine-grained data from more data regimes. In some situations, and strictly as another example, the quality threshold might be based on commercial arrangements.

To facilitate the collection of additional information that would increase the quality score, one or more action requests 122 are issued from data quality analysis engine 130 to user device 104₁ (operation 5). Strictly as one example, in response to one or more of such action requests, user 102₁ may capture and submit a side-view (operation 6). Continuing this example, a side-view can might facilitate accurate diagnosis of a dermatological health issue such as a rash.

In response to receiving additional information (e.g., a set of 2D image data 116₂, 3D object data 118₂, etc.), the quality score is again updated by data quality analysis engine 130 (operation 7). As can be observed, quality score 140₀ now exceeds the quality threshold 142. As such, an information set (e.g., diagnosis summary with imagery) formed from the received multi-regime data can be published for access by one or more data consumers (operation 8).

Applications of the quantitative information quality measurement techniques disclosed herein facilitate improvements in computer functionality that serve to reduce the demand for computer memory, reduce the demand for computer processing power, reduce network bandwidth use, and reduce the demand for intercomponent communication. Specifically, consumption of such computing resources to generate, process, and transmit low-quality (e.g., fraudulent, irrelevant, unusable, etc.) data or information can be eliminated when applying the herein-disclosed techniques. Moreover, certain techniques disclosed herein eliminate the consumption of computing resources associated with certain 3D object data conversions (e.g., voxelization, etc.).

In the scenario depicted in FIG. 1, the information for which a quantitative quality measure is to be determined pertains to a health issue. In this case, the target field is a body part or an affected area of a body part. The herein disclosed techniques can apply to contexts and/or environments other than healthcare. For example, a quantitative measurement of the quality of information provided by an insured party in a non-health insurance claim may be required. In this case, the target field might be an area of a damaged car, residential home, commercial building, or equipment item. Other contexts and/or environments are possible.

One embodiment of techniques for determining such quantitative measurements of information quality is disclosed in further detail as follows.

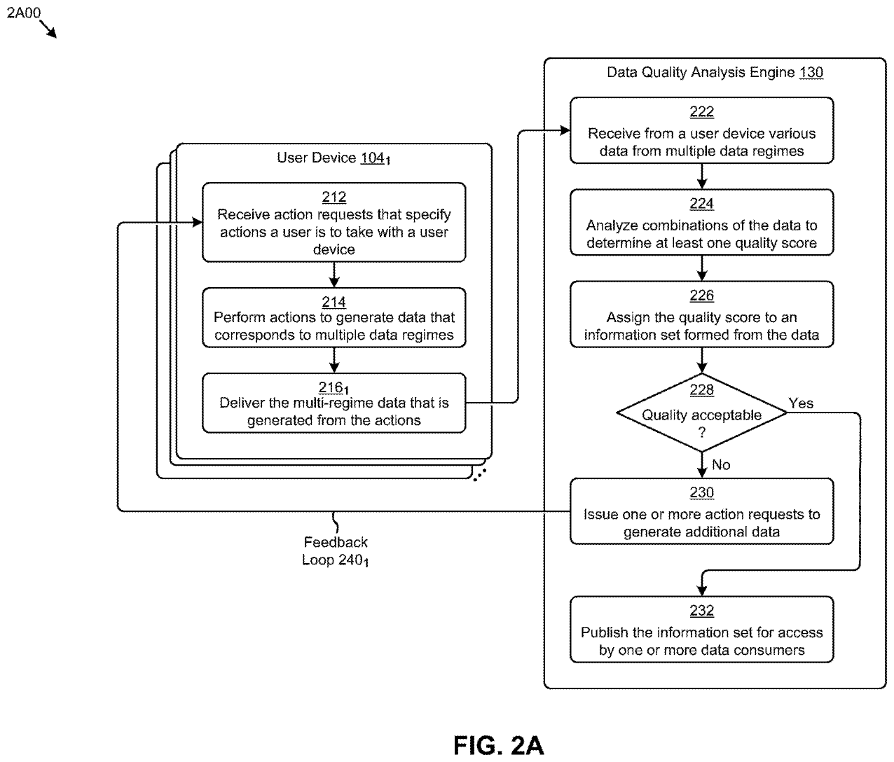

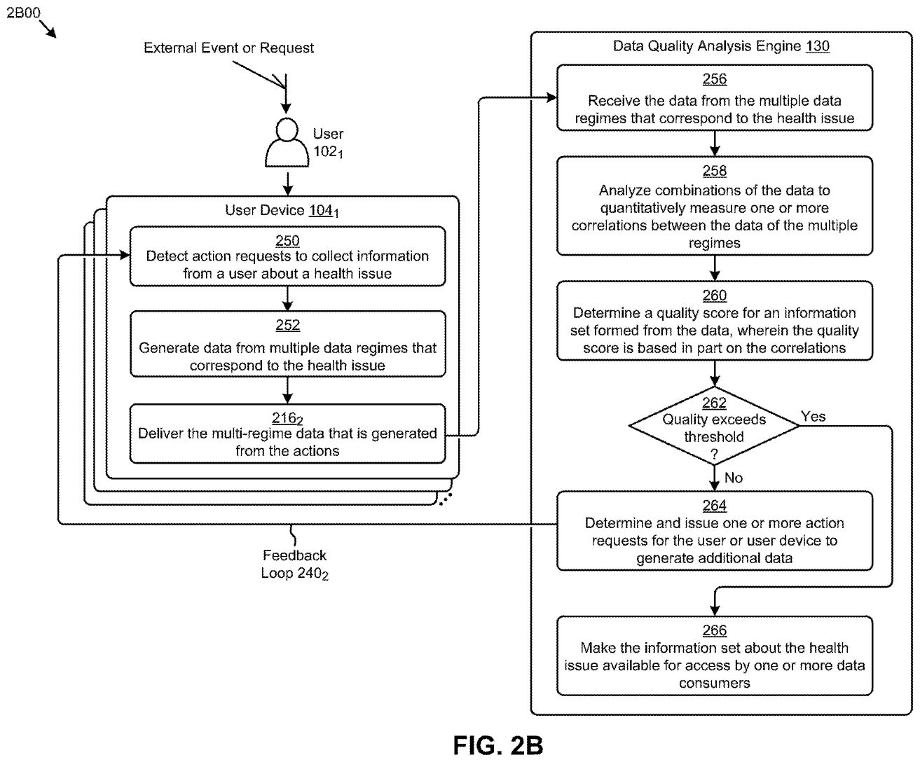

FIG. 2A depicts an information quality measurement technique 2A00 as implemented in systems that determine quality scores for information received from a user device. As an option, one or more variations of information quality measurement technique 2A00 or any aspect thereof may be implemented in the context of the architecture and functionality of the embodiments described herein. The information quality measurement technique 2A00 or any aspect thereof may be implemented in any environment.

FIG. 2A illustrates aspects pertaining to analyzing data from multiple correlated data regimes to determine quality scores for sets of user-provided information. Specifically, the figure is presented to illustrate one embodiment of certain steps and/or operations performed over various devices (e.g., user devices, servers, systems, etc.) and agents (e.g., applications, engines, etc.) on those devices to collect information from user devices that is of sufficient quality (e.g., authenticity, relevance, etc.) for its intended purpose. As can be observed in the embodiment of FIG. 2A, a first portion of the steps and/or operations can be performed at a user device (e.g., user device 104₁) and a second portion of the steps and/or operations can be performed at one or more instances of an agent (e.g., data quality analysis engine 130) that is separate from the user devices.

Information quality measurement technique 2A00 commences by receiving action requests at user device 104₁ that specify certain actions a user is to take with the user device (step 212). For example, the action requests might instruct the user to interact with the user device to answer certain questions or take a photograph of an object. The user performs the actions at the user device to generate various data that correspond to multiple data regimes (step 214). In the foregoing example, data associated with a text-based data regime are generated from the user's responses to the questions, and data of a 2D image data regime (e.g., sensor data and corresponding metadata) are contemporaneously captured. The multi-regime data generated in response to performing the actions are then delivered to various recipients (step 216₁).

As can be observed, one such recipient is data quality analysis engine 130. Specifically, data quality analysis engine 130 receives from a user device (e.g., user device 104₁) various data from multiple data regimes (step 222). As an example, such data regimes might include a 3D object data regime, a 2D image data regime, a sensor data regime, a text-based data regime, a biometrics data regime, and/or other data regimes. Combinations of the data from the data regimes are analyzed to determine at least one quality score (step 224). For example, at least a portion of a quality score might be derived from a measure of a correlation (e.g., consistency) of the data from two or more data regimes (e.g., a 2D image data regime and a sensor data regime). The quality score is then assigned to an information set that is formed from the data (step 226). In some cases, an information set might be a summary of the data that comprises a brief description and representative photograph of a target field.

If the quality (e.g., as indicated by the quality score) of the information set and/or underlying data is acceptable (“Yes” path of decision 228), then the information set is published for access by one or more data consumers (step 232). For example, a quality score threshold might be established by a health insurance data consumer to achieve a certain likelihood that a claim can be processed from the published information set.

If the quality (e.g., as indicated by the quality score) of the information set and/or underlying data is not acceptable (“No” path of decision 228), then one or more action requests are issued to generate additional data (step 230). As an example, an action request to retake a certain photograph might be issued to the user of user device 104₁. In this case, the action request and the resulting additional data are expected to improve the quality score. As depicted by feedback loop 240₁ of FIG. 2A, action requests can be issued—and additional data received—in a continuous loop so as to iteratively improve the quality of the user-provided data over time.

One embodiment of techniques for determining quantitative measurements of information quality in a healthcare environment is disclosed in further detail as follows.

FIG. 2B depicts a healthcare information quality measurement technique 2B00 as implemented in systems that determine quality scores for information received from a user device. As an option, one or more variations of healthcare information quality measurement technique 2B00 or any aspect thereof may be implemented in the context of the architecture and functionality of the embodiments described herein. The healthcare information quality measurement technique 2B00 or any aspect thereof may be implemented in any environment.

FIG. 2B illustrates aspects pertaining to analyzing data from multiple correlated data regimes to determine quality scores for sets of user-provided information. Specifically, the figure is presented to illustrate one embodiment of certain steps and/or operations performed over various devices (e.g., user devices, servers, systems, etc.) and agents (e.g., applications, engines, etc.) on those devices to collect health-related information from user devices that is of sufficient quality (e.g., authenticity, relevance, etc.) for its intended purpose, such as to provide a diagnosis of a health issue, or process a health insurance claim. As can be observed in the embodiment of FIG. 2B, a first portion of the steps and/or operations can be performed at one or more user devices (e.g., user device 104₁) and a second portion of the steps and/or operations can be performed at one or more instances of an agent (e.g., data quality analysis engine 130) that is separate from the user devices.

Healthcare information quality measurement technique 2B00 commences by detecting action requests at a user device (e.g., user device 104₁) that specify certain actions a user (user 102₁) is to take with the user device that pertain to a health issue (step 250). As can be observed, certain external events and/or requests might be presented to user 102₁ to invoke the action requests at user device 104₁. Specifically, the user might experience some health issue (e.g., injury, etc.) and, in response, launch an application on a user device (e.g., smart phone, tablet, etc.) to report the injury and/or issue.

In this case, the action requests might instruct the user to interact with the user device to answer certain questions or take a photograph of the affected area. The user performs the actions at the user device to generate various data from multiple data regimes that correspond to the health issue (step 252). In the foregoing example, data associated with a text-based data regime might describe the issue as selected from a dropdown menu and/or as written in the user's own words. Data associated with a 2D image data regime might also be generated to record the photograph of the affected area. The multi-regime data generated in response to performing the actions are then delivered to various recipients (step 216₂).

As can be observed, one such recipient is data quality analysis engine 130. Specifically, data quality analysis engine 130 receives from a user device (e.g., user device 104₁) various data from multiple data regimes that correspond to the particular health issue (step 256). As an example, such data might include questionnaire answers, 2D photographs, 2D videos, depth data (e.g., from a TrueDepth camera, or from an Intel® RealSense camera, or from an Xbox® Kinect device, etc.), multi-camera data, gyroscope data, user credentials and touch ID, and/or other data from other data regimes. Combinations of the data are analyzed to quantitatively measure one or more correlations between the data of the multiple data regimes (step 258).

For example, various 2D image data (e.g., multiple frames in a video) might be analyzed to quantitatively measure temporal distortions. As another example, 2D image data and depth data might be analyzed to quantitatively measure spatial distortions. Based at least in part on the aforementioned correlations, a quality score for an information set formed from the data is determined (step 260). As an example, a cumulative quality score for the information set might be calculated from a normalized weighted sum of the correlation measurements associated with the data underlying the information set.

In some cases, a quality score might be compared to a quality score threshold to determine whether the quality of an information set is acceptable or not acceptable for the purpose of the information set. For example, a quality score threshold might be established by a health insurance data consumer to achieve a certain likelihood that a claim can be processed from the information set. If the quality (e.g., as indicated by the quality score) of the information set and/or underlying data exceed a corresponding quality score threshold (“Yes” path of decision 262), then the information set associated with the health issue is published for access by one or more data consumers (step 266).

If the quality of the information set and/or underlying data (e.g., as indicated by the quality score) is below a quality score threshold (“No” path of decision 262), then one or more action requests are determined and issued to the user or user device to generate additional data (step 264). As an example, an action request to take a side-view photograph of the affected area might be issued to user 102₁ of user device 104₁. In this case, the action request and the resulting additional data are expected to improve the quality score of the user-provided healthcare information. As depicted by feedback loop 240₂ of FIG. 2B, the action requests and corresponding additional data can be continuously communicated to iteratively improve the quality of the user-provided healthcare data.

One embodiment of a system, data flows, and data structures for implementing the information quality measurement techniques of FIG. 2A and FIG. 2B, and/or other herein disclosed techniques, is disclosed as follows.

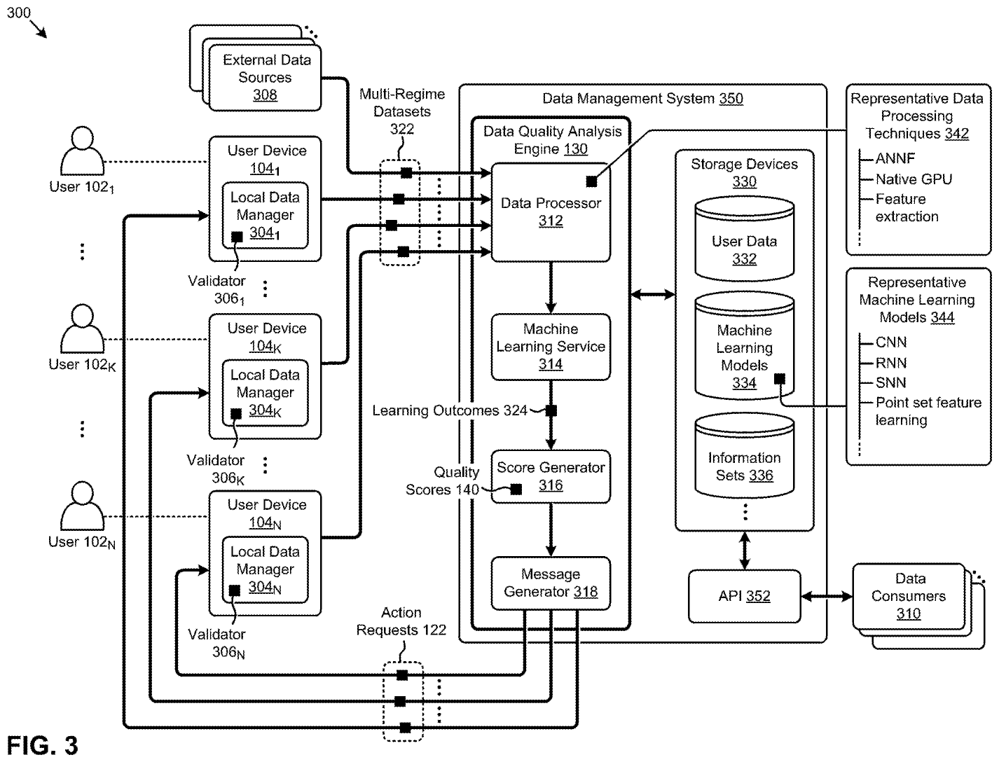

FIG. 3 presents a block diagram of a system 300 that makes data quality determinations based on information received from a user device. As an option, one or more variations of system 300 or any aspect thereof may be implemented in the context of the architecture and functionality of the embodiments described herein. The system 300 or any aspect thereof may be implemented in any environment.

FIG. 3 illustrates aspects pertaining to analyzing data from multiple correlated data regimes to determine quality scores for sets of user-provided information. Specifically, the figure is being presented to show one embodiment of certain representative components, together with associated data structures and associated data flows, might be used in a computing environment that comprises a data management system 350. The components, data flows, and data structures shown in FIG. 3 present merely one partitioning and merely one data manipulation approach. As such, the specific example shown is purely illustrative, and other subsystems, data structures, and/or partitioning are reasonable.

As shown, system 300 comprises an instance of data quality analysis engine 130 earlier described operating at data management system 350. Data quality analysis engine 130 comprises a data processor 312, a machine learning service 314, a score generator 316, and a message generator 318. A plurality of instances of the foregoing components might operate at a plurality of instances of servers at data management system 350 and/or any portion of system 300. Such instances can access a set of storage devices 330 that store various information that facilitates operation of the system 300 and/or implementation of the herein disclosed techniques.

Specifically, various users (e.g., user 102₁, . . . , user 102_{K}, . . . , user 102_{N}) can interact with the user interfaces of certain applications (e.g., local data manager 304₁, . . . , local data manager 304_{K}, . . . , local data manager 304_{N}) at their respective user devices (e.g., user device 104₁, . . . , user device 104_{K}, . . . , user device 104_{N}) to submit various user-provided data to data quality analysis engine 130 for analysis. For example, a local data manager at a particular user device might carry out certain instructions (e.g., action requests) and/or present certain instructions to be carried out by a respective user. The local data manager facilitates access to certain native capabilities and/or components (e.g., cameras, sensors, GPUs, artificial intelligence hardware accelerators, etc.) of the user device to carry out the actions and generate the corresponding data. In some cases, the local data manager may have a validator (e.g., validator 306₁, . . . , validator 306_{K}, . . . , validator 306_{N}) to validate the data (e.g., for format, syntax, etc.) before submitting it to data quality analysis engine 130. In other cases, the local data manager may perform other data processing (e.g., point cloud generation, etc.) at the user device. As described infra, an instance of the local data manager might be downloaded and installed on the user devices to facilitate operation of the herein disclosed techniques.

As shown, the various instances of multi-regime datasets 322 from the user devices are received by data processor 312 at data quality analysis engine 130. Certain instances of multi-regime datasets 322 may be received from one or more external data sources 308. For example, a corpus of 2D image data (e.g., photographs) of healthy and unhealthy body parts may be acquired, analyzed and stored by data quality analysis engine 130 for use as references when analyzing user-provided photographs. Among other functions, data processor 312 transforms the received data so as to facilitate consumption by machine learning service 314. As depicted in a set of representative data processing techniques 342, data processor 312 deploys multiple techniques to carry out such data transformations. Specifically, data processor 312 might deploy an approximate nearest-neighbor field (ANNF) technique (e.g., FeatureMatch) to integrate certain 2D image data (e.g., a video) and sensor data (e.g., a gyroscope data) into 3D object data (e.g., a point cloud). In some cases, a native GPU framework (e.g., Metal from Apple®) might be used to facilitate the 3D object data generation. In some cases, depth data can be combined with corresponding image-related data such as iterative closest point (ICP) data to generate point clouds.

Various techniques for extracting features from the multi-regime data may also be implemented at data processor 312. Moreover, additionally or alternatively, other processing techniques not described in the foregoing data processing techniques are possible. The processed data are then stored in sets of user data 332 in storage devices 330.

The processed data in user data 332 is accessed by machine learning service 314 and analyzed by applying the data to one or more machine learning models. The model parameters and/or other information that characterize the machine learning models accessible to machine learning service 314 are stored in a set of machine learning models 334 in storage devices 330. As indicated by a set of representative machine learning models 344, multiple models may be accessed to facilitate the herein disclosed techniques. Specifically, machine learning service 314 might apply a convolutional neural network (CNN) to identify a target object in a user-provided photograph. A combination of CNN layers and recurrent neural network (RNN) layers might be applied to identify temporal inconsistencies in user-provided photographs. A single shot detector (SSD) for proposing and classifying objects and/or a Siamese neural network (SNN) for comparing two sets of data might be applied to various sets of 3D object data (e.g., point clouds) to identify similarities, and/or dissimilarities and/or inconsistencies between the data sets. Various point set feature learning techniques may be combined with single shot detectors and/or Siamese neural networks to determine a measure of similarity between point sets (e.g., point clouds). Other models and/or techniques not described in the representative machine learning models 344 are possible.

Application of many of the foregoing techniques generates one or more quantitative measurements of a correlation (e.g., consistency, similarity, difference, etc.) between various datasets from the data regimes. The set of learning outcomes 324 (e.g., quantitative correlation measures) produced by machine learning service 314 are accessed by score generator 316 to determine instances of quality scores 140. Each quality score is assigned to a corresponding instance of information sets 336 recorded in storage devices 330. In some cases, any of the generated instances of the quality scores from any iteration might be improved by collecting additional data from the users and their user devices. In such cases, message generator 318 will access the quality scores 140 to generate one or more instances of action requests 122 to issue to respective user devices. The local data managers at the user devices will present the action requests 122 to facilitate generation and collection of the additional data. When the quality score of a particular information set indicates the information set is ready for publication, the information set is marked for publication in information sets 336. Any one of a set of data consumers 310 that is authorized to access the published information set can interface (e.g., through an API 352) with data management system 350 to access the information set.

The foregoing discussions include techniques for receiving various data from multiple data regimes (e.g., step 222 of FIG. 2A), which techniques and data are disclosed in further detail as follows.

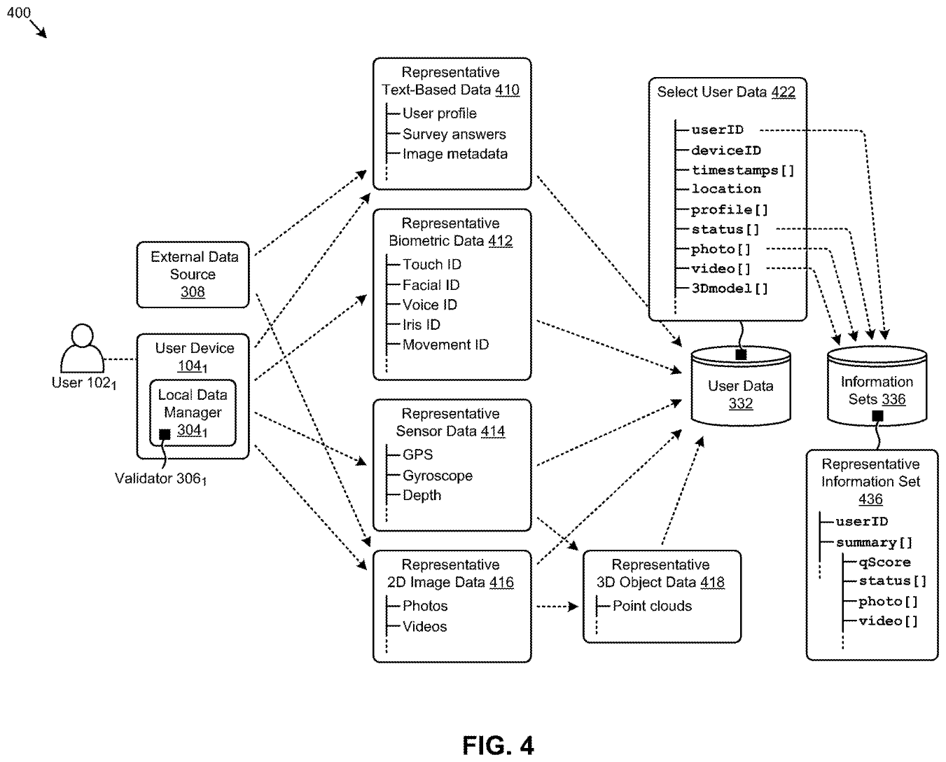

FIG. 4 depicts a multi-regime data collection technique 400 as implemented in systems that determine quality scores for information received from a user device. As an option, one or more variations of multi-regime data collection technique 400 or any aspect thereof may be implemented in the context of the architecture and functionality of the embodiments described herein. The multi-regime data collection technique 400 or any aspect thereof may be implemented in any environment.

FIG. 4 illustrates aspects pertaining to analyzing data from multiple correlated data regimes to determine quality scores for sets of user-provided information. Specifically, the figure is being presented to illustrate one embodiment of the data regimes and the data comprising the data regimes that are generated, received, processed, transformed, analyzed, and/or otherwise manipulated when implementing the herein disclosed techniques. The figure further illustrates a logical depiction of data flows when receiving such data in accordance with the herein disclosed techniques (e.g., step 222 of FIG. 2A).

The datasets described herein can be organized and/or stored using various techniques. Specifically, the data structures corresponding to the datasets shown in FIG. 4 are designed to improve the way a computer stores and retrieves data in memory when performing steps and/or operations pertaining to measuring the quality of user-provided information. For example, the data comprising user data 332 might be organized and/or stored in a tabular structure (e.g., relational database table) that has rows that relate various information, such as status descriptions and photographs, to a particular user. As another example, the information might be organized and/or stored in a programming code object that has instances corresponding to a user and properties corresponding to the various attributes associated with the user. As depicted by the shown select user data 422, a user data record (e.g., table row or object instance) for a particular user might describe a user identifier (e.g., stored in a “userID” field), a user device identifier (e.g., stored in a “deviceID” field), dataset capture timestamps (e.g., stored in a “timestamps []” object), a geographical location of the user device (e.g., stored in a “location” field), a set of user profile information (e.g., stored in a “profile []” object), a set of status information (e.g., stored in a “status []” object), one or more photographs and associated metadata (e.g., stored in a “photo []” object), one or more videos and associated metadata (e.g., stored in a “video []” object), one or more 3D objects and associated metadata (e.g., stored in a “3Dmodel []” object), and/or other user information. In some cases, multiple different videos are captured, where the multiple different videos correspond to different views. Accordingly, the one or more videos and associated metadata, including timecode or other time-oriented data might be stored in a “video []” object. Moreover, various instances of such user data can be used, for example, to track the progress (e.g., as described in “status []”, “photo []”, etc.) of a user's health over time (e.g., at each “timestamp”).

As can be observed, user data 332 is populated at least in part from various datasets received from user device 104₁ of user 102₁ and an external data source 308. Specifically, sets of text-based data received from user device 104₁ and external data source 308 can comprise user profile attributes, survey answers, image metadata, and/or other text-based data, as depicted in a set of representative text-based data 410. According to a set of representative 2D image data 416, the aforementioned image metadata may correspond to certain photos, videos, and/or other 2D image data from user device 104₁ and/or external data source 308. A set of representative biometric data 412 indicates that data corresponding to a touch ID, facial ID, voice ID, iris ID, movement ID, and/or other biometrics associated with user 102₁ may be received from user device 104₁. Furthermore, according to representative sensor data 414, certain GPS data, gyroscope data, depth data, and/or other sensor data might be received from user device 104₁. In some cases, certain data from two or more data regimes might be combined into a dataset in an existing or new data regime. For example, representative 3D object data 418 indicates that a point cloud and/or other sets of 3D object data may be derived from certain sensor data and 2D image data.

Furthermore, aspects that serve to correlate the timing of capture of the foregoing user data can be recorded in these or other data structures. As examples, the user might capture a first data set (e.g., a video) during a first capture time window. Contemporaneously with the capture of the first data set (e.g., under programmatic control by operation of the local data manager), a second data set (e.g., accelerometer data or gyroscopic data) may be captured. This second data set may be captured in a second capture time window that overlaps the first capture time window. As such, one or more timings (e.g., timestamps) pertaining to the first data set and its corresponding one or more timings (e.g., timestamps) pertaining to the second data set can be correlated on the basis of capture times. Specifically, when the second capture time window overlaps at least a portion of the first capture time window, a correlation between the first data set and the second data set can be established. In some embodiments, the correlation can be recorded as dataset capture timestamps (e.g., stored in the aforementioned “timestamps []” object).

As earlier discussed, information sets are often formed from the user data and/or other information for sharing with various data consumers. Such information sets (e.g., information sets 336) might be subsets of the full corpus of user data to facilitate efficient access to the portion of the user data that is most relevant to a particular data consumer. For example, a remote healthcare provider might initially need merely a brief high-quality description and an image of a body part and/or an image of equipment and/or some other image pertaining a health issue being experienced by a patient (e.g., a user). As illustrated in FIG. 4, select portions (e.g., fields, objects, etc.) of the data records of user data 332 may be used to populate the information sets 336.

Other data, such as quality scores determined according to the herein disclosed techniques, may also be recorded in information sets 336. More specifically, as indicated by a representative information set 436, an information set associated with a particular user might describe a user identifier (e.g., stored in a “userID” field), a then-current summary of the user's state (e.g., stored in a “summary []” object), and/or other information associated with the user. As further indicated in representative information set 436, the “summary []” object may comprise a quality score (e.g., stored in a “qScore” field), a set of status information (e.g., stored in a “status []” object), one or more photographs and associated metadata (e.g., stored in a “photo []” object), one or more videos and associated metadata (e.g., stored in a “video []” object), and/or other summary information. In some cases, certain results (e.g., a diagnosis, an outcome, etc.) generated from the herein disclosed analyses over the user-provided information might be included in the information set (e.g., in the “status []” object).

The foregoing discussions include techniques for analyzing combinations of the aforementioned data from multiple data regimes to determine at least one quality score (e.g., step 224 of FIG. 2A), which techniques are disclosed in further detail as follows.

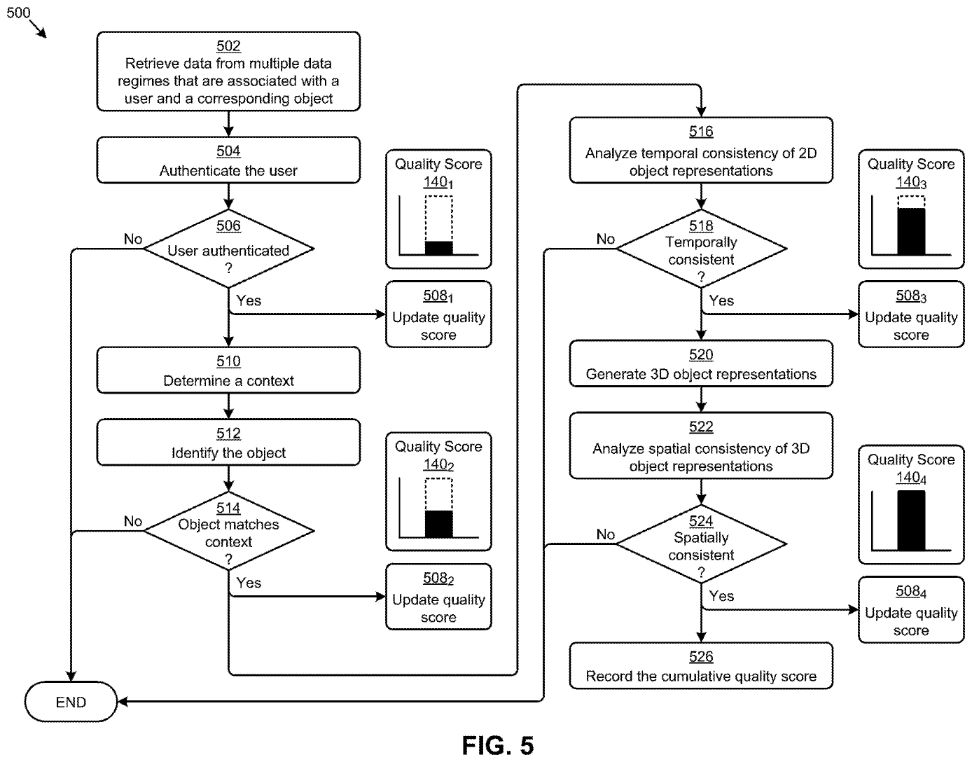

FIG. 5 presents an information quality assessment technique 500 as implemented in systems that determine quality scores for information received from a user device. As an option, one or more variations of information quality assessment technique 500 or any aspect thereof may be implemented in the context of the architecture and functionality of the embodiments described herein. The information quality assessment technique 500 or any aspect thereof may be implemented in any environment.

FIG. 5 illustrates aspects pertaining to analyzing data from multiple correlated data regimes to determine quality scores for sets of user-provided information. Specifically, the figure is presented to illustrate one embodiment of certain steps and/or operations that facilitate analyzing combinations of data from multiple data regimes to determine at least one quality score (e.g., step 224 of FIG. 2A). A representative quality score scenario is also shown in the figure to illustrate an example application of information quality assessment technique 500.

Information quality assessment technique 500 commences by retrieving data from multiple data regimes that are associated with a user and a corresponding object (step 502). For example, the user might be a patient interested in providing information about a rash on their arm (e.g., the “object”) to a remote healthcare professional for assessment. The user providing the data is authenticated (step 504). As an example, biometric and/or other data (e.g., login credentials) received from the user device of the user are analyzed to authenticate the user. If the user is not authenticated (“No” path of decision 506), no further analysis of the data is performed. In this case, for example, an action request may be issued to the user to retry one or more authentication operations at the user device (e.g., login again, recapture a touch ID, etc.). If the user is authenticated (“Yes” path of decision 506), a quality score associated with the retrieved data is updated (step 508₁). As illustrated in quality score 140₁, a successful user authentication might account for a relatively small portion of a target quality score (e.g., as depicted by the dotted bar).

If the user is authenticated (“Yes” path of decision 506), further analysis of the data from the multiple data regimes is also performed to determine a context for the information (step 510). For example, a set of text-based data describing answers to various questions might be analyzed to determine that the user has a skin-related issue (e.g., a rash) to be assessed. The data is then analyzed to identify the object as described and/or photographed and/or videotaped by the user (step 512). As an example, a CNN technique might be implemented to identify an object (e.g., a body part) in a set of user-provided 2D object representations (e.g., photograph) as compared to various photographs of sick and healthy body parts. If the identified body part does not match the earlier determined context (“No” path of decision 514), no further processing of the data is performed. If the identified body part matches the earlier determined context (“Yes” path of decision 514), the quality score associated with the retrieved data is updated (step 508₂). As illustrated in a quality score 140₂, a photograph and/or video that matches the specified context adds to the overall quality of the data (e.g., as depicted by the dotted bar).

If the 2D object representations matches the context (“Yes” path of decision 514), further analysis of the 2D object representations is performed to determine the temporal consistency of the representations (step 516). For example, one or more neural networks formed using a combination of CNN and RNN layers might be applied to the 2D image data to identify temporal inconsistencies (e.g., as produced by a GAN) in the user-provided object representations (e.g., photographs, videos, etc.). If the 2D object representations are not temporally consistent (“No” path of decision 518), no further processing of the data is performed. If the 2D object representations are temporally consistent (“Yes” path of decision 518), the quality score associated with the retrieved data is updated (step 508₃). As illustrated by quality score 140₃, having an unaltered photograph and/or video of the correct object from an authenticated user results in a relatively high quality score. As can be observed by quality score 140₃, further additional data and/or data analyses are required to achieve the target quality score (e.g., as depicted by the dotted bar).

Such additional analyses might include generating various 3D object representations from the user-provided data (step 520) and analyzing the 3D object representations for spatial consistency (step 522). For example, two or more point clouds generated from sets of 2D image data and sensor data (e.g., gyroscope data, depth data, etc.) might be directly analyzed using point set feature learning techniques, and/or other techniques to identify any spatial inconsistencies and/or temporal inconsistencies, and/or other inconsistencies between the point clouds. Such consistency analyses performed directly on the point clouds might detect, for example, a photograph and/or video of a target object that is not associated with the user (e.g., it is a view of another person's arm) and/or is not taken by the user, which characteristics may affect the deemed data quality of the photograph and/or video and/or overall dataset. If the 3D object representations are not spatially consistent (“No” path of decision 524), no further processing of the data is performed. If the 3D object representations are spatially consistent (“Yes” path of decision 524), the quality score associated with the retrieved data is updated (step 508₄) and the cumulative quality score is recorded (step 526). As illustrated by quality score 140₄, confirmation of the spatial consistency of the 3D object data increases the quality score so as to achieve the target quality score.

An application of the various techniques disclosed herein for measuring the quality of user-provided information are described in detail in the following.

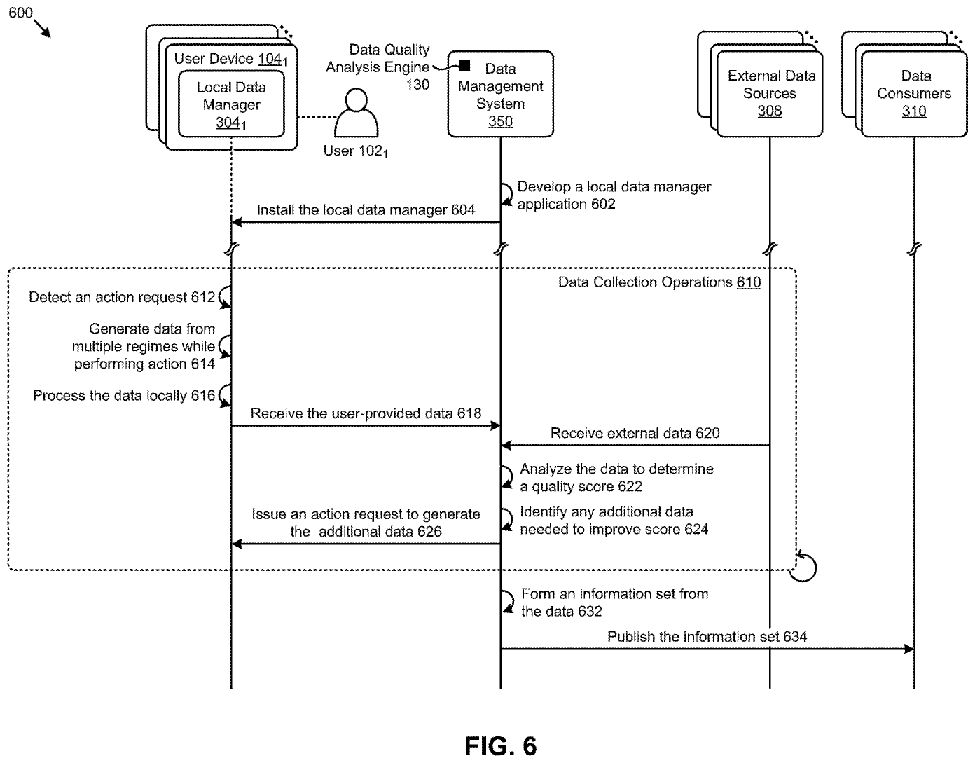

FIG. 6 illustrates an information sourcing scenario 600 for making data quality determinations based on information received from a user device. As an option, one or more variations of information sourcing scenario 600 or any aspect thereof may be implemented in the context of the architecture and functionality of the embodiments described herein. The information sourcing scenario 600 or any aspect thereof may be implemented in any environment.

FIG. 6 illustrates aspects pertaining to analyzing data from multiple correlated data regimes to determine quality scores for sets of user-provided information. Specifically, the figure is being presented to illustrate a representative information sourcing scenario in which a quantitative measurement of the quality of the information is determined according to the herein disclosed techniques. The high order interactions (e.g., operations, messages, etc.) of the scenario are performed by various computing components earlier described. The particular computing components shown in FIG. 6 are data management system 350 comprising data quality analysis engine 130, user device 104₁ corresponding to user 102₁ and comprising local data manager 304₁, external data sources 308, and data consumers 310.

Information sourcing scenario 600 commences with development of a local data manager application (operation 602). For example, an enterprise associated with data management system 350 might develop an application or app (e.g., for iOS, or for Android, or for some other operating system of platform, etc.) to facilitate retrieval of user-provided information from user devices such as user device 104₁. An instance of the local data manager (e.g., local data manager 304₁) developed at data management system 350 is downloaded and installed at user device 104₁ (message 604).

At some later moment in time, a set of data collection operations 610 commence by detecting an action request at local data manager 304₁ of user device 104₁ (operation 612). Various data are generated while performing the action that corresponds to the action request (operation 614). Such data may be from multiple data regimes. For example, an action request to take a photograph of an object might generate a set of 2D image data and a set of text-based data. In some cases, certain local processing of the generated data is performed (operation 616). For example, the data might be validated for proper syntax or format. In other cases, some of the machine learning techniques as described herein might be applied at the user device. Specifically, certain operations over 3D object data (e.g., point clouds) might be performed at the user device (e.g., as facilitated by the local data manager). Based at least in part on the results of the foregoing local processing, near real-time feedback can be presented to user 102₁ by local data manager 304₁ to improve the quality of the user-provided data.

The generated and/or processed data that is provided by the user is then received at data quality analysis engine 130 of data management system 350 (message 618). Data quality analysis engine 130 might also receive certain sets of data from external data sources 308 (message 620). For example, a set of reference data that pertains to the context of the user-provided information might be received from one or more external sources. The data is analyzed to determine a quality score to associate with the user-provided data (operation 622). Any additional data needed to improve the quality score is identified (operation 624) and an action request to generate the additional data is issued to user device 104₁ (message 626). The high order interactions that constitute the data collection operations 610 can be repeated until a target quality score is achieved. In some cases, data collection operations might cease prior to achieving a target quality score, such as when all opportunities for collecting additional data have been exhausted. When the data collection operations are completed, an information set is formed at data management system 350 from the user-provided data and/or other data (operation 632). The information set is then published for access by one or more of the data consumers 310 (message 634).

### Additional Embodiments of the Disclosure

### Additional Practical Application Examples

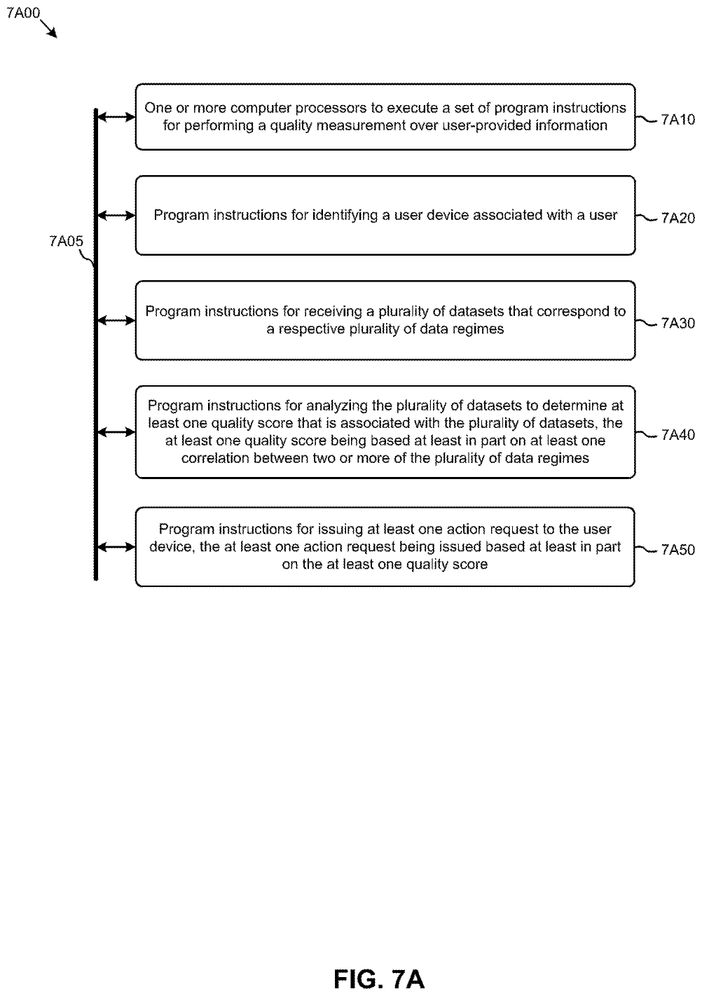

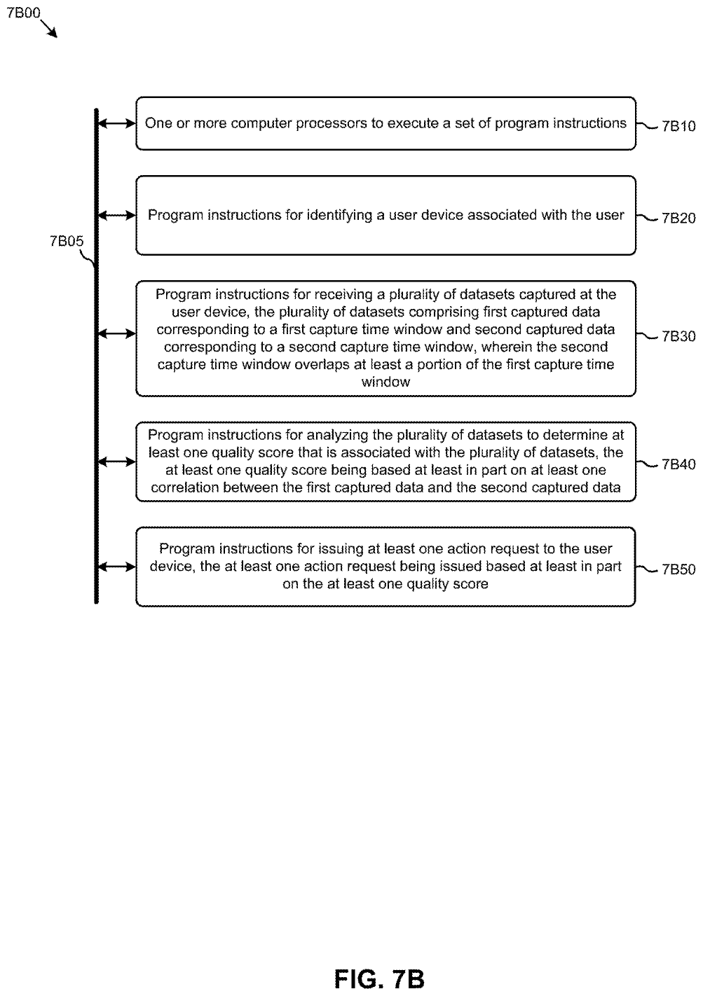

FIG. 7A depicts a system 7A00 as an arrangement of computing modules that are interconnected so as to operate cooperatively to implement certain of the herein-disclosed embodiments. This and other embodiments present particular arrangements of elements that, individually or as combined, serve to form improved technological processes that address collecting information from user devices that is of sufficient quality for its intended purpose. The partitioning of system 7A00 is merely illustrative and other partitions are possible. As an option, the system 7A00 may be implemented in the context of the architecture and functionality of the embodiments described herein. Of course, however, the system 7A00 or any operation therein may be carried out in any desired environment.

The system 7A00 comprises at least one processor and at least one memory, the memory serving to store program instructions corresponding to the operations of the system. As shown, an operation can be implemented in whole or in part using program instructions accessible by a module. The modules are connected to a communication path 7A05, and any operation can communicate with any other operations over communication path 7A05. The modules of the system can, individually or in combination, perform method operations within system 7A00. Any operations performed within system 7A00 may be performed in any order unless as may be specified in the claims.

The shown embodiment implements a portion of a computer system, presented as system 7A00, comprising one or more computer processors to execute a set of program instructions (module 7A10) and modules for accessing memory to hold program instructions to perform: identifying a user device associated with a user (module 7A20); receiving a plurality of datasets that correspond to a respective plurality of data regimes (module 7A30); analyzing the plurality of datasets to determine at least one quality score that is associated with the plurality of datasets, the at least one quality score being based at least in part on at least one correlation between two or more of the plurality of data regimes (module 7A40); and issuing at least one action request to the user device, the at least one action request being issued based at least in part on the at least one quality score (module 7A50).

Variations of the foregoing may include more or fewer of the shown modules. Certain variations may perform more or fewer (or different) steps and/or certain variations may use data elements in more, or in fewer, or in different operations.

Still further, some embodiments include variations in the operations performed, and some embodiments include variations of aspects of the data elements used in the operations.

FIG. 7B depicts a system 7B00 as an arrangement of computing modules that are interconnected so as to operate cooperatively to implement certain of the herein-disclosed embodiments. The partitioning of system 7B00 is merely illustrative and other partitions are possible. As an option, the system 7B00 may be implemented in the context of the architecture and functionality of the embodiments described herein. Of course, however, the system 7B00 or any operation therein may be carried out in any desired environment. The system 7B00 comprises at least one processor and at least one memory, the memory serving to store program instructions corresponding to the operations of the system. As shown, an operation can be implemented in whole or in part using program instructions accessible by a module. The modules are connected to a communication path 7B05, and any operation can communicate with any other operations over communication path 7B05. The modules of the system can, individually or in combination, perform method operations within system 7B00. Any operations performed within system 7B00 may be performed in any order unless as may be specified in the claims. The shown embodiment implements a portion of a computer system, presented as system 7B00, comprising one or more computer processors to execute a set of program code instructions (module 7B10) and modules for accessing memory to hold program code instructions to perform: identifying a user device associated with the user (module 7B20); receiving a plurality of datasets captured at the user device, the plurality of datasets comprising first captured data corresponding to a first capture time window and second captured data corresponding to a second capture time window, wherein the second capture time window overlaps at least a portion of the first capture time window (module 7B30); analyzing the plurality of datasets to determine at least one quality score that is associated with the plurality of datasets, the at least one quality score being based at least in part on at least one correlation between the first captured data and the second captured data (module 7B40); and issuing at least one action request to the user device, the at least one action request being issued based at least in part on the at least one quality score (module 7B50).

### System Architecture Overview

### Additional System Architecture Examples

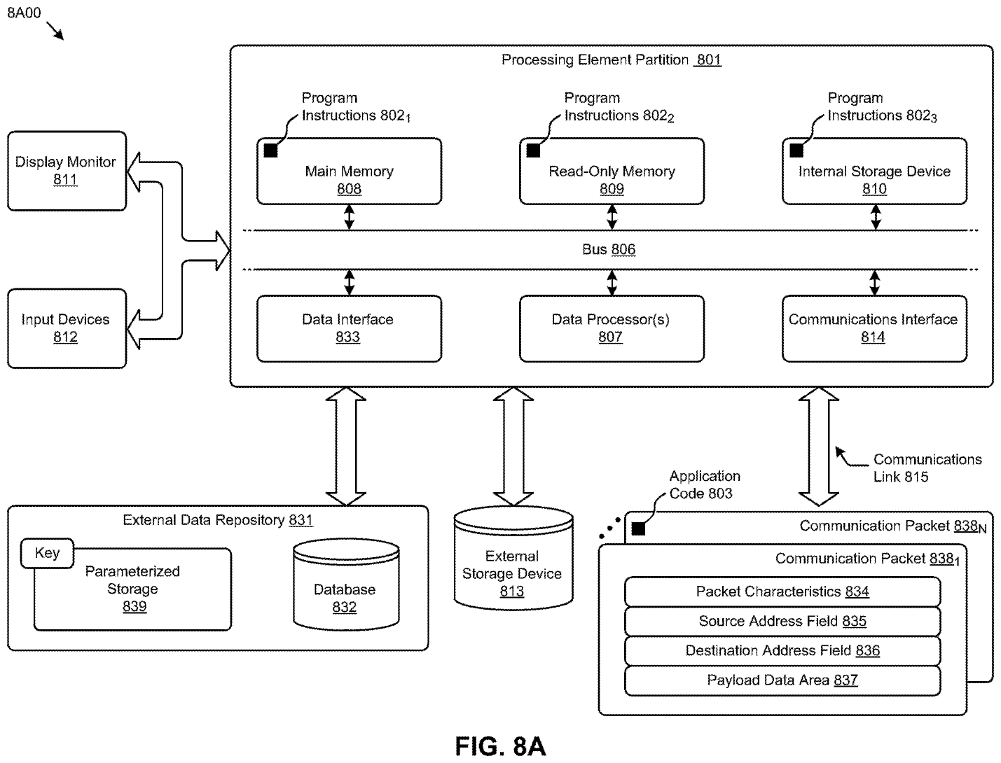

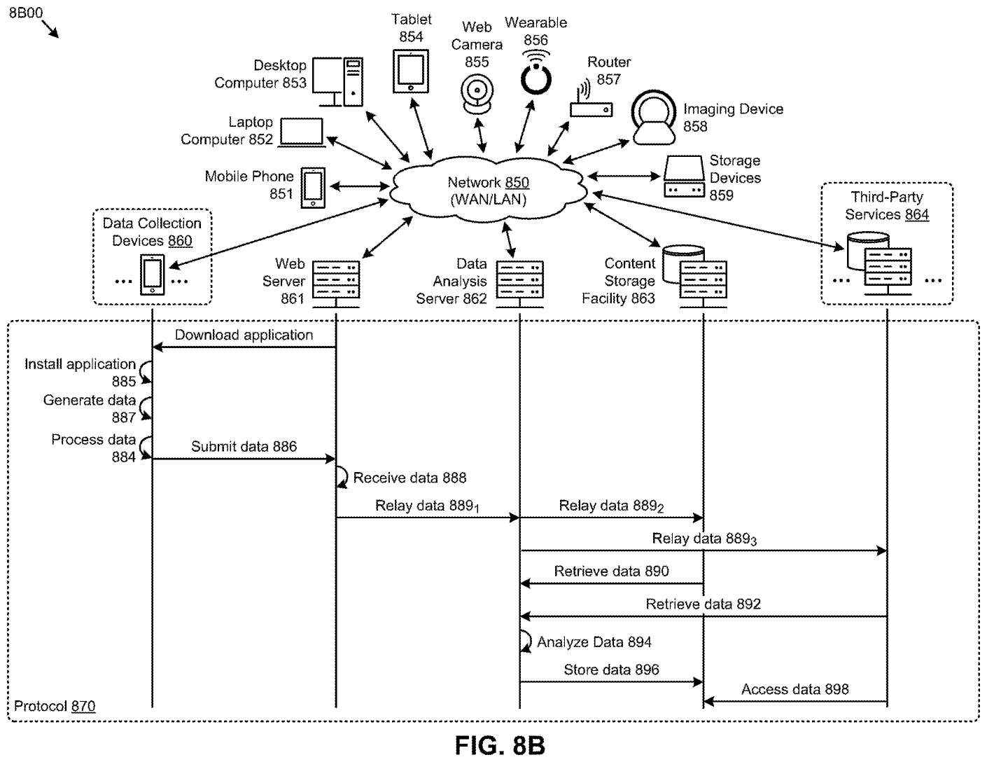

FIG. 8A depicts a block diagram of an instance of a computer system 8A00 suitable for implementing embodiments of the present disclosure. Computer system 8A00 includes a bus 806 or other communication mechanism for communicating information. The bus interconnects subsystems and devices such as a central processing unit (CPU), or a multi-core CPU (e.g., data processor 807), a system memory (e.g., main memory 808, or an area of random access memory (RAM)), a non-volatile storage device or non-volatile storage area (e.g., read-only memory 809), an internal storage device 810 or external storage device 813 (e.g., magnetic or optical), a data interface 833, a communications interface 814 (e.g., PHY, MAC, Ethernet interface, modem, etc.). The aforementioned components are shown within processing element partition 801, however other partitions are possible. Computer system 8A00 further comprises a display 811 (e.g., CRT or LCD), various input devices 812 (e.g., keyboard, cursor control), and an external data repository 831.

According to an embodiment of the disclosure, computer system 8A00 performs specific operations by data processor 807 executing one or more sequences of one or more program instructions contained in a memory. Such instructions (e.g., program instructions 802₁, program instructions 802₂, program instructions 802₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 8A00 performs specific networking operations using one or more instances of communications interface 814. Instances of communications interface 814 may comprise one or more networking ports that are configurable (e.g., pertaining to speed, protocol, physical layer characteristics, media access characteristics, etc.) and any particular instance of communications interface 814 or port thereto can be configured differently from any other particular instance. Portions of a communication protocol can be carried out in whole or in part by any instance of communications interface 814, and data (e.g., packets, data structures, bit fields, etc.) can be positioned in storage locations within communications interface 814, or within system memory, and such data can be accessed (e.g., using random access addressing, or using direct memory access DMA, etc.) by devices such as data processor 807.

Communications link 815 can be configured to transmit (e.g., send, receive, signal, etc.) any types of communications packets (e.g., communication packet 838₁, communication packet 838_{N}) comprising any organization of data items. The data items can comprise a payload data area 837, a destination address 836 (e.g., a destination IP address), a source address 835 (e.g., a source IP address), and can include various encodings or formatting of bit fields to populate packet characteristics 834. In some cases, the packet characteristics include a version identifier, a packet or payload length, a traffic class, a flow label, etc. In some cases, payload data area 837 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 807 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 831, which in turn can be formatted into any one or more storage areas, and which can comprise parameterized storage 839 accessible by a key (e.g., filename, table name, block address, offset address, etc.).

Execution of the sequences of instructions to practice certain embodiments of the disclosure are performed by a single instance of a computer system 8A00. According to certain embodiments of the disclosure, two or more instances of computer system 8A00 coupled by a communications link 815 (e.g., LAN, public switched telephone network, or wireless network) may perform the sequence of instructions required to practice embodiments of the disclosure using two or more instances of components of computer system 8A00.

Computer system 8A00 may transmit and receive messages such as data and/or instructions organized into a data structure (e.g., communications packets). The data structure can include program instructions (e.g., application code 803), communicated through communications link 815 and communications interface 814. Received program code may be executed by data processor 807 as it is received and/or stored in the shown storage device or in or upon any other non-volatile storage for later execution. Computer system 8A00 may communicate through a data interface 833 to a database 832 on an external data repository 831. Data items in a database can be accessed using a primary key (e.g., a relational database primary key).

Processing element partition 801 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 807. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to determining a quantitative measurement of quality for information received from a user device. A module may include one or more state machines and/or combinational logic used to implement or facilitate the operational and/or performance characteristics pertaining to determining a quantitative measurement of quality for information received from a user device.

Various implementations of database 832 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of determining a quantitative measurement of quality for information received from a user device). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to determining a quantitative measurement of quality for information received from a user device, and/or for improving the way data is manipulated when performing computerized operations for analyzing data from multiple correlated data regimes to determine quality scores for sets of user-provided information.

FIG. 8B depicts an environment 8B00 in which embodiments of the present disclosure can operate. As an option, one or more aspects shown in environment 8B00 or any combination of components of the environment may be implemented in the context of the architecture and functionality of the embodiments described herein.

As shown environment 8B00 comprises various computing systems (e.g., servers and devices) interconnected by a network 850. The network 850 can comprise any combination of a wide area network (e.g., WAN), local area network (e.g., LAN), cellular network, wireless LAN (e.g., WLAN), or any such means for enabling communication of computing systems. The network 850 can also be referred to as “the Internet” or as an “Internet”. The example environment 8B00 comprises data collection devices 860, an instance of a web server 861, an instance of a data analysis server 862, a content storage facility 863, and optional instances of third-party services 864, which third-party services 864 may communicate with any other the other operational element over a network.

The servers and devices shown in environment 8B00 can represent any single computing system with dedicated hardware and software, or the servers and devices shown in environment 8B00 can represent multiple computing systems connected together (e.g., in a server farm, or in a host farm, etc.). In some cases, multiple computing systems share resources. For example, the web server 861 and the data analysis server 862 might be closely coupled (e.g., co-located) and/or might be implemented using the same hardware platform.

The environment 8B00 further comprises a variety of other devices such as a mobile phone 851, a laptop 852, a desktop computer 853, a tablet 854, a web camera 855, and a wearable device 856 etc. The environment further comprises computing equipment such as a router 857, an imaging device 858 (e.g., CT scanner, MRI machine, etc.), and any number of storage devices 859, etc. Some or all of the foregoing computing devices and computing equipment may support software (e.g., a browser, mobile application, etc.) and hardware (e.g., an LCD display, a graphics processing unit, display, monitor, etc.) capable of processing and displaying information (e.g., an image, a web page, etc.). Any of the foregoing computing devices or computing equipment can serve as one of the data collection devices 860.

In some embodiments, any particular one of the data collection devices 860 can be used in conjunction with a different particular one of the data collection devices to determine the location and/or identity of a user.

As shown, the computing devices and computing equipment can perform a set of high-level interactions (e.g., operations, messages, etc.) in a protocol 870. Specifically, the protocol can represent interactions in systems for measuring the quality of user-provided information. Any of the data collection devices 860 can download an application from web server 861 and install the application (operation 885). The application can be used to capture and/or generate data (operation 887), process the captured or generated data (operation 884), and submit data to the web server (message 886).

The web server is configured to receive data (operation 888) corresponding to the data submitted from the data collection devices. Such received data may be relayed or otherwise transmitted (message 889₁, or message 889₂, or message 889₃) to downstream computing equipment such as data analysis server 862, and/or to a content storage facility 863, and/or to any one or more third party services 864. Furthermore, the data analysis server may retrieve data (message 890) from any storage facility, including from content storage facility 863 or any one or more of the third party services (message 892).

An instance of a data analysis server 862 can be configured to autonomously (e.g., under program control) analyze any received data (message 894). Moreover, example instances of a data analysis server 862 can be configured to store data (message 896) at any storage facility, including at content storage facility 863 or any one or more storage devices of third-party services.

In some cases, the third-party services produce additional data that is derived, directly or indirectly, from the data received from the data collection devices. In some cases, and as shown, such additional data might be still further retrieved (message 898) and analyzed by data analysis server 862. As such, data can be transformed in a cascading fashion. Specifically, data can be initially processed at the data collection device, then alternatively or additionally, the resulting data can be processed at the data analysis server, then alternatively or additionally, the still further resulting data can be processed at the third-party services.

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method for performing a quality measurement of information provided by a user, the method comprising:
identifying a user device associated with the user;
receiving a plurality of datasets captured at the user device, the plurality of datasets comprising,
first captured data corresponding to a first capture time window and
second captured data corresponding to a second capture time window,
wherein the second capture time window overlaps at least a portion of the first capture time window;
analyzing the plurality of datasets to determine at least one quality score that is associated with the plurality of datasets, the at least one quality score being based at least in part on at least one correlation between the first captured data and the second captured data; and
issuing at least one action request to generate additional data at the user device of the user, the at least one action request being issued based at least in part on the at least one quality score.

2. The method of claim 1, wherein the first captured data corresponding to the first capture time window is one of: a video or an image.

3. The method of claim 1, wherein the second captured data corresponding to the second capture time window is one of: accelerometer data or gyroscopic data or GPS data.

4. The method of claim 1, further comprising:
receiving at least one additional dataset, the at least one additional dataset being received in response to fulfilling the at least one action request; and
analyzing the at least one additional dataset to update the at least one quality score.

5. The method of claim 1, wherein the first capture data or the second captured data comprise at least one of: three dimensional object data, two dimensional image data, sensor data, text-based data, or biometrics data.

6. The method of claim 1, wherein the at least one correlation is determined by applying one or more machine learning techniques to the plurality of datasets.

7. (canceled)

8. The method of claim 1, wherein one or more operations of the method are performed at the user device.

9. The method of claim 1, further comprising:
forming at least one information set, the at least one information set being formed at least in part from at least a portion of the plurality of datasets; and
assigning the at least one quality score to the at least one information set.

10. The method of claim 9, wherein the at least one information set is provided to one or more data consumers.

11. A non-transitory computer readable medium having stored thereon a sequence of instructions which, when stored in memory and executed by one or more processors causes the one or more processors to perform a set of acts for performing a quality measurement of information provided by a user, the set of acts comprising:
identifying a user device associated with the user;
receiving a plurality of datasets captured at the user device, the plurality of datasets comprising,
first captured data corresponding to a first capture time window and
second captured data corresponding to a second capture time window,
wherein the second capture time window overlaps at least a portion of the first capture time window;
analyzing the plurality of datasets to determine at least one quality score that is associated with the plurality of datasets, the at least one quality score being based at least in part on at least one correlation between the first captured data and the second captured data; and
issuing at least one action request to generate additional data at the user device of the user, the at least one action request being issued based at least in part on the at least one quality score.

12. The non-transitory computer readable medium of claim 11, wherein the first captured data corresponding to the first capture time window is one of: a video or an image.

13. The non-transitory computer readable medium of claim 11, wherein the second captured data corresponding to the second capture time window is one of: accelerometer data or gyroscopic data or GPS data.

14. The non-transitory computer readable medium of claim 11, further comprising instructions which, when stored in memory and executed by the one or more processors causes the one or more processors to perform acts of:
receiving at least one additional dataset, the at least one additional dataset being received in response to fulfilling the at least one action request; and
analyzing the at least one additional dataset to update the at least one quality score.

15. The non-transitory computer readable medium of claim 11, wherein the first capture data or the second captured data comprise at least one of: three dimensional object data, two dimensional image data, sensor data, text-based data, or biometrics data.

16. The non-transitory computer readable medium of claim 11, wherein the at least one correlation is determined by applying one or more machine learning techniques to the plurality of datasets.

17. (canceled)

18. The non-transitory computer readable medium of claim 11, further comprising instructions which, when stored in memory and executed by the one or more processors causes the one or more processors to perform acts of:
forming at least one information set, the at least one information set being formed at least in part from at least a portion of the plurality of datasets; and
assigning the at least one quality score to the at least one information set.

19. The non-transitory computer readable medium of claim 11, wherein at least a portion of the plurality of datasets is provided to one or more data consumers.

20. A method for performing a quality measurement over user-provided information, the method comprising:
identifying a user device associated with a user;
receiving a plurality of datasets that correspond to a respective plurality of data regimes;
analyzing the plurality of datasets to determine at least one quality score that is associated with the plurality of datasets, the at least one quality score being based at least in part on at least one correlation between two or more of the plurality of data regimes; and
issuing at least one action request to generate additional data at the user device of the user, the at least one action request being issued based at least in part on the at least one quality score.

21. The method of claim 20, further comprising:
forming at least one information set, the at least one information set being formed at least in part from at least a portion of the plurality of datasets; and
assigning the at least one quality score to the at least one information set.

22. The method of claim 20, wherein the at least one information set is provided to one or more data consumers.

23. The method of claim 20, wherein the at least one information set comprises at least one of: the at least one quality score, a summary, a photograph, a video, a status, a diagnosis, or an outcome.

24. The method of claim 20, further comprising:
receiving at least one additional dataset, the at least one additional dataset being received in response to fulfilling the at least one action request; and
analyzing the at least one additional dataset to update the at least one quality score.

25. The method of claim 20, wherein the plurality of data regimes comprises at least one of: a 3D object data regime, a 2D image data regime, a sensor data regime, a text-based data regime, or a biometrics data regime.

26. A system for performing a quality measurement of information provided by a user, the system comprising:
a storage medium having stored thereon a sequence of instructions; and
one or more processors that execute the instructions to cause the one or more processors to perform a set of acts, the set of acts comprising,
establishing a connection with a user device that is associated with the user;
receiving a plurality of datasets that correspond to a respective plurality of data regimes;
analyzing the plurality of datasets to determine at least one quality score that is associated with the plurality of datasets, the at least one quality score being based at least in part on at least one correlation between two or more of the plurality of data regimes; and
issuing at least one action request to generate additional data at the user device of the user, the at least one action request being issued based at least in part on the at least one quality score.

27. The system of claim 26, wherein the plurality of datasets comprise at least one of: a video or an image.

28. The system of claim 26, wherein the at least one correlation is determined by applying one or more machine learning techniques to the plurality of datasets.

29. (canceled)

30. The system of claim 26, wherein the at least one correlation corresponds to a spatial consistency associated with two or more sets of 3D object data.

31. The method of claim 1, wherein the additional data comprises at least one of, a request to retake a photograph, or a request to take a side-view photograph, or a request to generate text-based data.

32. The non-transitory computer readable medium of claim 11, wherein the additional data comprises at least one of, a request to retake a photograph, or a request to take a side-view photograph, or a request to generate text-based data.

33. The system of claim 26, wherein the additional data comprises at least one of, a request to retake a photograph, or a request to take a side-view photograph, or a request to generate text-based data.
